(19) United States
(12) Patent Application Publication
(10) Pub. No.: US 2006/0230362 A1
(43) Pub. Date: Oct. 12, 2006

(54) Information management program product allowing enhanced searchability

(75) Inventor: Katsuhiko Matsusaka, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/185,802

(22) Filed: Jul. 21, 2005

(30) Foreign Application Priority Data
Apr. 12, 2005 (JP) 2005-114609

(51) Int. Cl. G06F 17/00

(52) U.S. Cl. 715/838

(57) ABSTRACT

When thumbnails displayed indicating document files stored in a database are changed in size to “large” the thumbnails all have their respective thumbnail frames unchanged in size and the number of thumbnails displayed is also unchanged while the thumbnailed and thus displayed document files have their respective thumbnails ranges reduced and displayed under increased magnification.

This application is based on Japanese Patent Application No. 2005-114609 filed with the Japan Patent Office on Apr. 12, 2005, the entire content of which is hereby incorporated by reference.

### BACKGROUND OF THE INVENTION

1. Field of the Invention

The present invention relates generally to information management program products and information management apparatuses and particularly to such products and apparatuses facilitating to retrieve desired information from stored information.

2. Description of the Related Art

In a document management system assuming management of hierarchically stored document files and/or other similar information an application for browsing files is utilized to display small images (or thumbnails) indicating stored document files to help a user to search for a desired document file.

A thumbnail is displayed by a variety of techniques proposed for example as follows:

Japanese Laid-Open Patent Publication No. 2000-83161 proposes an image processor that subjects only an object of an original image that satisfies a prescribed condition to a plurality of types of conversion and outputs a result thereof in a thumbnail to help a user to recognize the result.

Japanese Laid-Open Patent Publication No. 2001-186334 proposes an image processor that can consider an original image's aspect ratio in creating a thumbnailed image for an appropriate image range so that whether the original image may be a vertically long image or a horizontally long image, the thumbnail can provide an indication that can facilitate a user to recognize its content.

Japanese Laid-Open Patent Publication No. 2002-14854 proposes a method of creating a thumbnail icon that can designate any portion of a file as a range to be thumbnailed to help a user to learn the file's content.

FIG. 13 shows one example of a screen displayed in a typical document management system using an application to display a thumbnail indicating a document file stored in such a method as described above.

With reference to FIG. 13, this specific example shows a displayed screen including a “tree area” indicating a hierarchical structure of folders and a “displaying area” displaying in a thumbnail the information stored in a folder selected in the tree area. The displaying area displays a thumbnail changeable in size and this specific example employs an application allowing a thumbnail to be set in sizes “large”, “medium” and “small” for a total of three sizes.

If FIG. 13 shows thumbnails in the size “small”, and with this size the user cannot determine the indicated files' contents, then, as shown in FIG. 14, a menu or the like can be displayed and therefrom the thumbnails' size can be changed to “medium” or “large”. FIG. 14 shows one example of a screen displayed when the FIG. 13 thumbnail size “small” has been changed to “large”.

Typically, however, such an application prepares a displaying area fixed in size, and increasing thumbnails in size results in a reduced number of thumbnails that can be displayed and as a result the user has difficulty in finding a desired document file.

More specifically, if the thumbnail size “small” allows six thumbnails to be displayed, as shown in FIG. 13, changing the size to “large” allows only six or less (in FIG. 14, four) thumbnails to be displayed and the user would have difficulty in finding a desired document file.

### SUMMARY OF THE INVENTION

The present invention has been made to address such issue and it contemplates an information management program and information management apparatus that can eliminate the necessity of changing a thumbnail in size to help a user to search through stored information to retrieve desired information.

To achieve the above object the present invention in one aspect provides an information management program product causing a computer to execute an information management process including the steps of: generating thumbnail data based on a data file and employed to display a thumbnail indicating the data file; designating a size of the thumbnail; and determining a thumbnail range serving as a range of the thumbnail data that is displayed as the thumbnail, the thumbnail range being determined as based on a predetermined size of an area displaying a single thumbnail, and a magnification of content displayed as the thumbnail that corresponds to the size of the thumbnail designated in the step of designating.

The present invention in another aspect provides a program product causing a computer to execute an information management process including the steps of: generating first thumbnail data based on a first data file and employed to display a first thumbnail indicating the first data file, and second thumbnail data based on a second data file and employed to display a second thumbnail indicating the second data file; determining a first thumbnail range serving as a range of the first thumbnail data that is displayed as the first thumbnail, and a second thumbnail range serving as a range of the second thumbnail data that is displayed as the second thumbnail; detecting for the first thumbnail displayed an instruction indicating that the first thumbnail range should be shifted; and shifting the first thumbnail range and the second thumbnail range in response to the instruction detected in the step of detecting.

The present invention in still another aspect provides a program product causing a computer to execute an information management process including the steps of: generating thumbnail data based on a data file and employed to display a thumbnail indicating the data file; determining a thumbnail range serving as a range of the thumbnail data that is displayed as the thumbnail; and entering an instruction to turn to a subsequent page a thumbnail range of the thumbnail displayed, wherein if in the step of determining, a displayed thumbnail indicating a data file having more than one page currently displays a page of the data file followed by any subsequent page of the thumbnail range, then in response to the instruction the subsequent page is determined as the thumbnail range.

The present invention in still another aspect provides a program product causing a computer to execute an information management process including the steps of: displaying in a thumbnail at least one data file having more than one page by using the page; receiving an instruction indicating that for the thumbnail displayed, a page should be turned; and changing the data file's thumbnailed and displayed portion in response to the instruction from a currently displayed page to a subsequent page.

The present invention in still another aspect provides a program product causing a computer to execute an information management process including the steps of: displaying a first thumbnail based on a first data file and indicating the first data file; displaying a second data file based on a second data file and indicating the second data file; detecting for the first thumbnail displayed an instruction indicating that a range to be displayed should be shifted; and shifting a range of the second thumbnail to be displayed as based on the instruction detected in the step of detecting.

The present invention in still another aspect provides an information management apparatus including: a thumbnail generator generating thumbnail data from a data file for displaying a thumbnail indicating the data file; a designator designating a size of the thumbnail; and a thumbnail range determiner determining a thumbnail range serving as a range of the thumbnail data that is displayed as the thumbnail, the thumbnail range being determined as based on a predetermined size of an area displaying a single thumbnail, and a magnification of content displayed as the thumbnail that corresponds to the size of the thumbnail designated by the designator.

The present invention in still another aspect provides an information management apparatus including: a thumbnail generator generating first thumbnail data based on a first data file and employed to display a first thumbnail indicating the first data file, and second thumbnail data based on a second data file and employed to display a second thumbnail indicating the second data file; a thumbnail range determiner determining a first thumbnail range serving as a range of the first thumbnail data that is displayed as the first thumbnail, and a second thumbnail range serving as a range of the second thumbnail data that is displayed as the second thumbnail; a detector detecting for the first thumbnail displayed an instruction indicating that the first thumbnail range should be shifted; and a shifter shifting the first thumbnail range and the second thumbnail range in response to the instruction detected by the detector.

The present invention in still another aspect provides an information management apparatus including: a thumbnail generator generating thumbnail data based on a data file and employed to display a thumbnail indicating the data file; a thumbnail range determiner determining a thumbnail range serving as a range of the thumbnail data that is displayed as the thumbnail; and an indicator entering an instruction indicating that the thumbnail's displayed thumbnail range should be turned to a subsequent page, wherein if a displayed thumbnail indicating a data file having more than one page currently displays a page of the data file followed by any subsequent page of the thumbnail range, then in response to the instruction the thumbnail range determiner determines the subsequent page as the thumbnail range.

The present invention in still another aspect provides an information management apparatus including: a display displaying in a thumbnail at least one data file having more than one page by using the page; an indicator receiving an instruction indicating that for the thumbnail displayed, a page should be turned; and a changer operative in response to the instruction to change the data file's thumbnailed and displayed portion from a currently displayed page to a subsequent page.

The present invention in still another aspect provides an information management apparatus including: a first display displaying a first thumbnail based on a first data file and indicating the first data file; a second display displaying a second data file based on a second data file and indicating the second data file; a detector detecting for the first thumbnail displayed an instruction indicating that a range to be displayed should be shifted; and a shifter shifting a range of the second thumbnail to be displayed as based on the instruction detected in the step of detecting.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a concept of a document management system in an embodiment.

FIG. 2 is a block diagram showing a specific example of a hardware configuration of a document management apparatus 100.

FIG. 3 is a block diagram showing a specific example of a configuration in function of the document management apparatus 100.

FIG. 4 is a block diagram showing a specific example of a configuration in function for effecting a process in the document management apparatus 100 to display a thumbnail indicating a document file.

FIG. 5 is a flow chart representing a process performed in the document management apparatus 100 to display a thumbnail.

FIG. 6 is a flow chart representing a process performed in the document management apparatus 100 to change a thumbnail in size.

FIG. 7 shows a specific example of displaying in a thumbnail.

FIG. 8 is a flow chart representing a process performed in the document management apparatus 100 to change a position in a thumbnail for indication.

FIG. 9 is a diagram for illustrating step S303.

FIGS. 10A-10C are diagrams for illustrating step S305.

FIG. 11 shows a specific example of displaying a thumbnail.

FIG. 12 is a flow chart representing a process performed in the document management apparatus 100 to turn a page of a thumbnail.

FIG. 13 shows a specific example of displaying a-thumbnail.

FIG. 14 shows a specific example of displaying a thumbnail by a conventional document management apparatus when the thumbnail is changed in size.

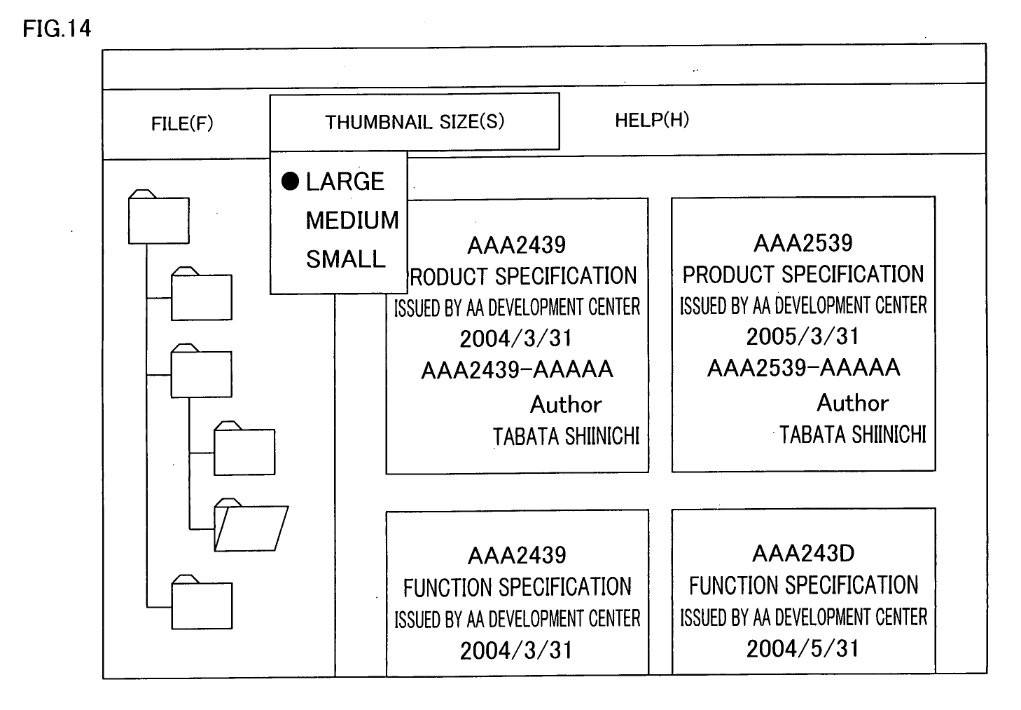

### DESCRIPTION OF THE PREFERRED EMBODIMENTS

Hereinafter the drawings will be referred to, to describe the present invention in embodiment. In the following description, identical parts and components are identically labeled and are also identical in name and function.

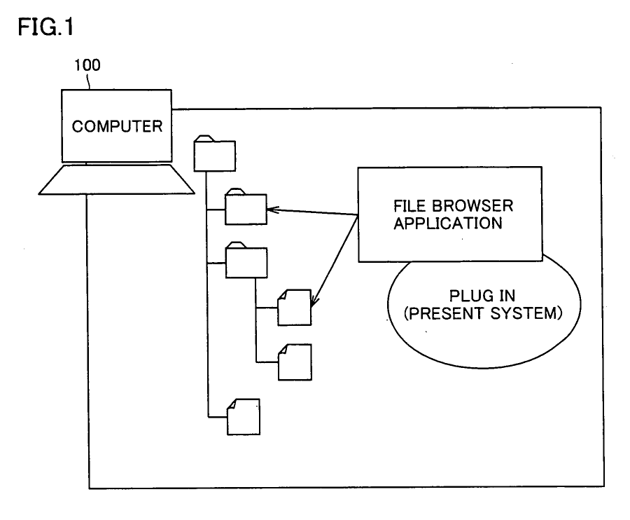

With reference to FIG. 1, the present embodiment provides a document management system in which a document management apparatus 100 implemented as one example of an information management apparatus by a personal computer executing one example of an information management program implemented by a document management program, assumes management of a plurality of document files stored in folders hierarchically.

Document management apparatus 100 implemented by the personal computer may be employed standalone or in a networked environment. In the former case, the plurality of document files are stored in the apparatus itself In the latter case, the plurality of document files may be stored in a different, networked apparatus.

Document management apparatus 100 implemented by the personal computer includes an application allowing a plurality of stored document files to be browsed and a user can utilize this application to access a specific file. A specific example of the application is Microsoft's Explorer®.

In the present embodiment the document management program extends the above application's function and is installed in document management apparatus 100 as plug in software for the application for the sake of illustration.

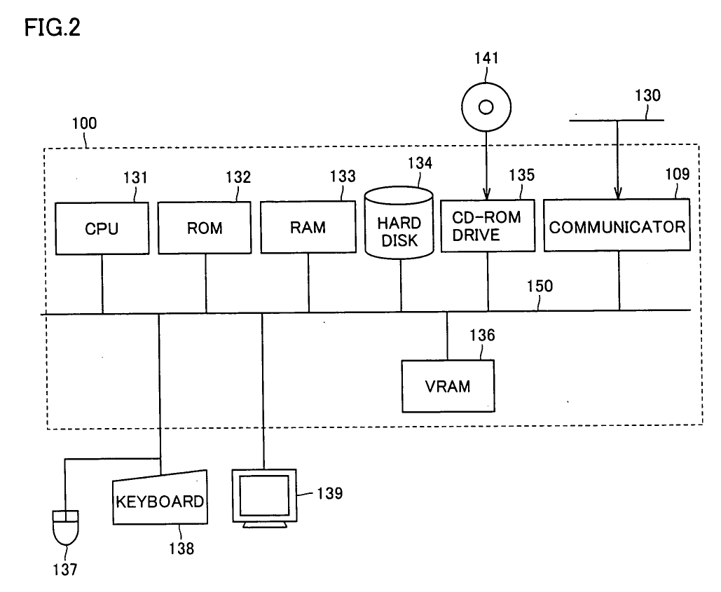

As has been described above, in the present embodiment document management apparatus 100 is implemented by a personal computer. Accordingly, the FIG. 2 hardware configuration is a typical personal computer's hardware configuration.

With reference to FIG. 2, document management apparatus 100 is configured including a central processing unit (CPU) 131, a read only memory (ROM) 132 storing a program or the like sent to an operating system, a random access memory (RAM) 133 for loading a program to be executed, and storing data while the program is executed, a hard disk 134 storing a document database in nonvolatile manner, a communicator 109 connecting document management apparatus 100 to a network 130, a mouse 137, a keyboard 138, a display 139 in the form of a cathode ray tube (CRT), a liquid crystal display device, a plasma display panel or a similar display device, a compact disk read only memory (CD-ROM) drive 135, and a video random access memory (VRAM) 136 serving as a memory holding content displayed on display 139, all connected to a bus 150. CD-ROM drive 135 receives a CD-ROM 141.

Thus document management apparatus 100 is implemented by a typical personal computer operating as well-known.

In the present embodiment's document management apparatus 100 a document management program is executed in CPU 131 and the document database stored in a memory 107 is subjected to management through a process. Generally such a document management program is stored in CD-ROM 141 or similar storage medium and thus distributed, and read by CD-ROM drive 135 from the storage medium and temporarily stored to hard disk 134, and furthermore read from the disk to RAM 133 and executed by CPU 131.

The storage medium is not limited to CD-ROM 141 and hard disk 134 and may be a flexible disk, a cassette tape, an optical disc (a magnetic optical (MO) disc)/a mini disk (MD)/a digital versatile disk (DVD)), an IC card, including a memory card, an optical card, mask ROM, EPROM, EEPROM, flash ROM or similar semiconductor memory serving as a medium carrying the program in a fixed manner.

The “program” as referred to herein is a concept including not only a program directly executable by CPU 131 but also a program in the form of a source program, a compressed and thus displayed program, an encrypted program and the like.

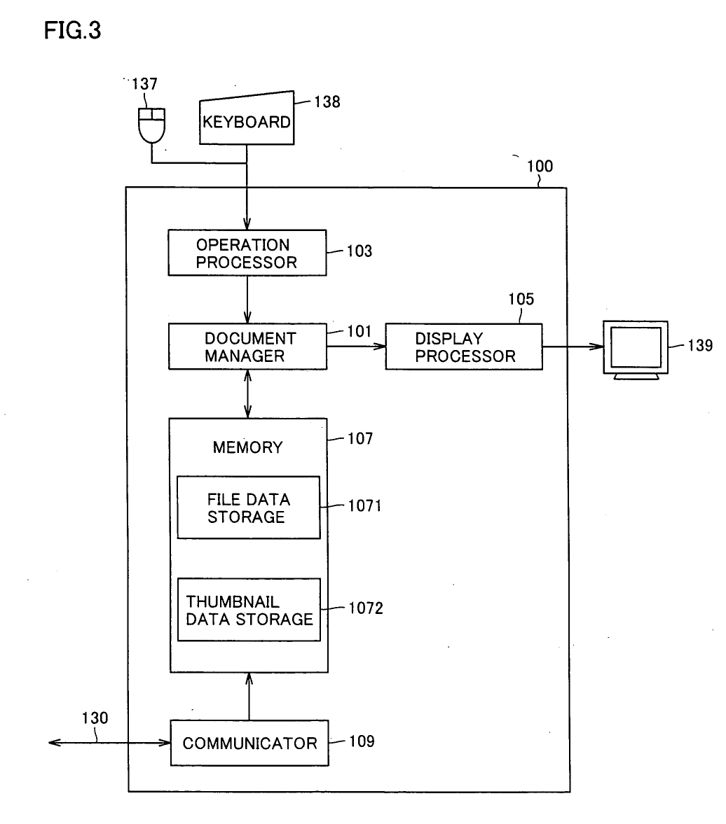

FIG. 3 shows components, which are created in the FIG. 2 CPU 131 as the document management program is executed by CPU 131.

With reference to FIG. 3, document management apparatus 100 includes an operation processor 103 outputting an operation signal based on an operation input by a user via mouse 137, keyboard 138 or the like, communicator 109 serving as an interface for communication through network 130 with a different apparatus, memory 107 storing for example a document file created in document management apparatus 100, a document file received at communicator 109, and the like, a document manager 101 assuming management of the document file stored in memory 107 and the like, and a display processor 105 operating in accordance with instruction of document manager 101 to perform a process to display specific information on display 139.

Memory 107 is nonvolatile memory of a hard disk drive or the like and corresponds for example to a prescribed location of hard disk 134 shown in FIG. 2. Memory 107 includes a file data storage 1071 serving as a document database storing a document file and a thumbnail data storage 1072 storing data employed to display a thumbnail indicating the document file.

Document manager 101 operates in response to an operation signal received from operation processor 103 to access file data storage 1071 and for example search for and retrieve, add, modify, and/or delete a document file or perform similar typical operation for the database to assume management of file data storage 1071, a document database included in memory 107. Furthermore, document manager 101 creates a thumbnail indicating a document file stored in file data storage 1071. Furthermore document manager 101 reads document file data from file data storage 1071 and thumbnail data from thumbnail data storage 1072 and outputs the data to display processor 105 to display the data on display 139.

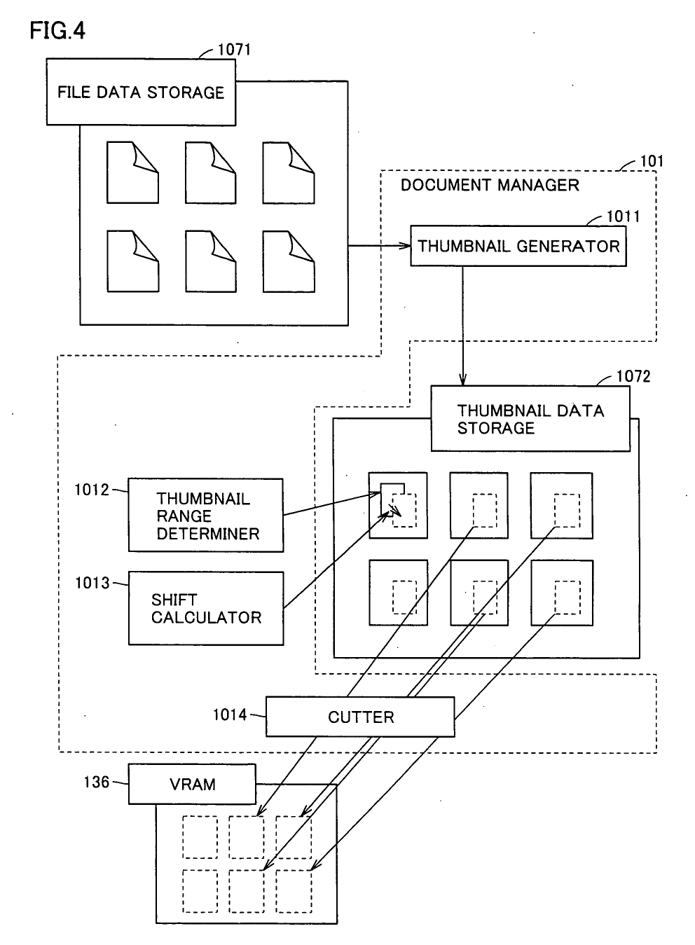

FIG. 4 is a block diagram showing a specific example of a configuration in function for executing a process in document management apparatus 100 for management of the document database to display a thumbnail indicating a document file stored in file data storage 1071. FIG. 4 shows a variety of components, which are created in document manager 101 created by CPU 131 as the document management program is executed by the FIG. 2 CPU 131.

With reference to FIG. 4, document manager 101 includes a thumbnail generator 1011 generating thumbnail data corresponding to data employed to display a thumbnail, a thumbnail range determiner 1012 determining a thumbnail range corresponding to a range of the thumbnail data that is displayed in a thumbnail, a shift calculator 1013 calculating an amount of shifting a displayed thumbnail from a first thumbnail range to a second thumbnail range corresponding to a range to be displayed as designated by a user through an operation, and a cutter 1014 cutting a thumbnail range from thumbnail data stored in thumbnail data storage 1072.

Thumbnail generator 1011 reads document file data of a document file stored in file data storage 1071 to generate and store thumbnail data to thumbnail data storage 1072.

Thumbnail range determiner 1012 determines a thumbnail range for the thumbnail data stored in thumbnail data storage 1072 and passes a resultant decision to cutter 1014.

Shift calculator 1013 operates in response to an operation signal received from operation processor 103 and indicating that a thumbnail range should be changed to calculate an amount of shifting the thumbnail range from the currently displayed thumbnail range (or a first thumbnail range) to a subsequently displayed thumbnail range (or a second thumbnail range) and pass the calculated amount to thumbnail range determiner 1012. Thumbnail range determiner 1012 determines the second thumbnail range from the received amount and the first thumbnail range and passes the determined second thumbnail range to cutter 1014.

Cutter 1014 cuts the received thumbnail range out of thumbnail data and extends or reduces and develops it in VRAM 136 to display it in an area of a prescribed size.

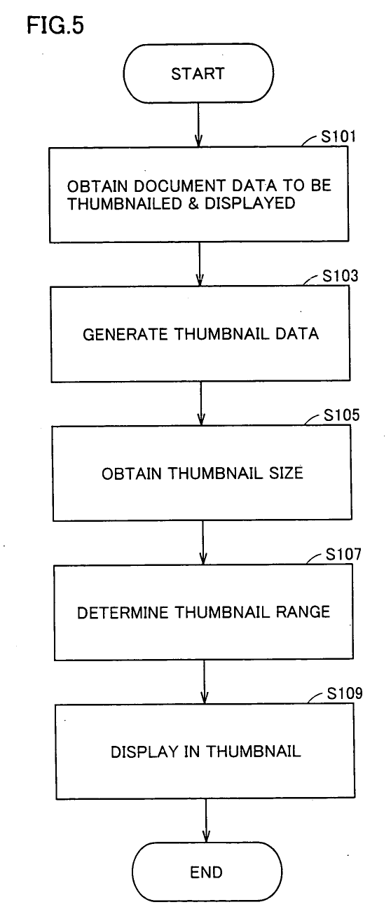

FIG. 5 represents a flow chart representing a thumbnail display process implemented as the document management program is executed by CPU 131 and mainly the FIG. 4 various functions are controlled.

With reference to FIG. 5, initially thumbnail generator 1011 accesses file data storage 1071 to obtain document file data of a document file subject to displaying a thumbnail (step S101) and generate thumbnail data (step S103). Step S103 is a step commonly known, as described for example in the aforementioned patent documents. More specifically, all of document file data corresponding to original data, a specific range thereof, or a specific portion (a diagram, a table or the like) thereof are subjected to resolution correction, color correction and/or the like to obtain thumbnail data. The thumbnail data created at step S103 is stored to thumbnail data storage 1072.

Steps S101 and S103 may be performed when Microsoft's Explorer® or a similar application for browsing a plurality of stored document files is initiated and a storage location is designated or the storage location is designated and displaying in a thumbnail is indicated, or the steps may previously be performed as timed as appropriate and thumbnail data may be stored to thumbnail data storage 1072.

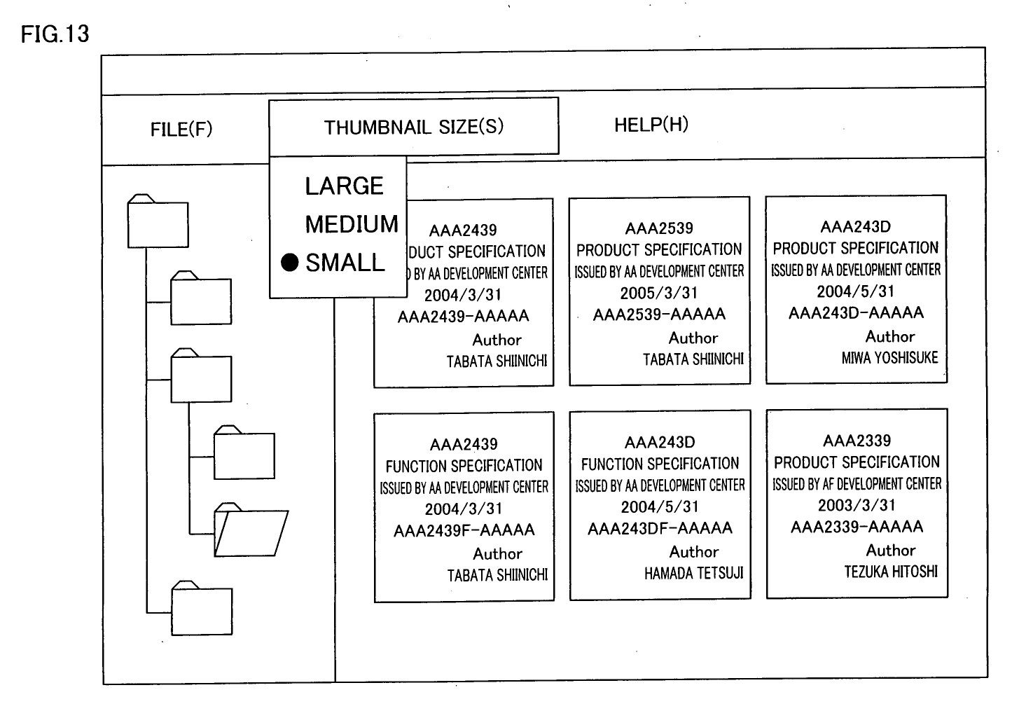

Then thumbnail range determiner 1012 obtains a thumbnail size together with a predetermined size of an area displaying a single thumbnail (hereinafter also referred to as a “thumbnail displaying frame”) stored for example in memory 107 (step S105). At step S105, of the three, or “large”, “medium” and “small”, settable thumbnail sizes, as shown in FIG. 13, a thumbnail size designated by an operation signal received from an operation processor 103 is obtained. Note that in the present embodiment a thumbnail size thus obtained indicates a size of a range to be thumbnailed, i. e., a magnification of content (or a document file) displayed in a thumbnail. If the thumbnail size “large” is selected a small range is thumbnailed and displayed under large magnification. If the thumbnail size “small” is selected a large range is thumbnailed and displayed under small magnification.

Furthermore, at step S105, a thumbnail size used in the immediately previous thumbnail display process may be recalled and used.

Thumbnail range determiner 1012 determines for specific thumbnail data stored in thumbnail data storage 1072 a range to be thumbnailed based for example on a thumbnail size and a size of a thumbnail displaying frame obtained at step S105, a position in a thumbnail, and the like (step S107). The position in the thumbnail may for example be a position set by default (e.g., the top of data) or may be that calculated from a current thumbnail range, as based on an amount of shifting calculated by shift calculator 1013.

Cutter 1014 accesses thumbnail data storage 1072 and cuts out of specified thumbnail data a thumbnail range as determined at step S107 and enlarges or reduces and then develops it in VRAM 136 as data to be displayed to allow display 139 to display a thumbnail (step S109).

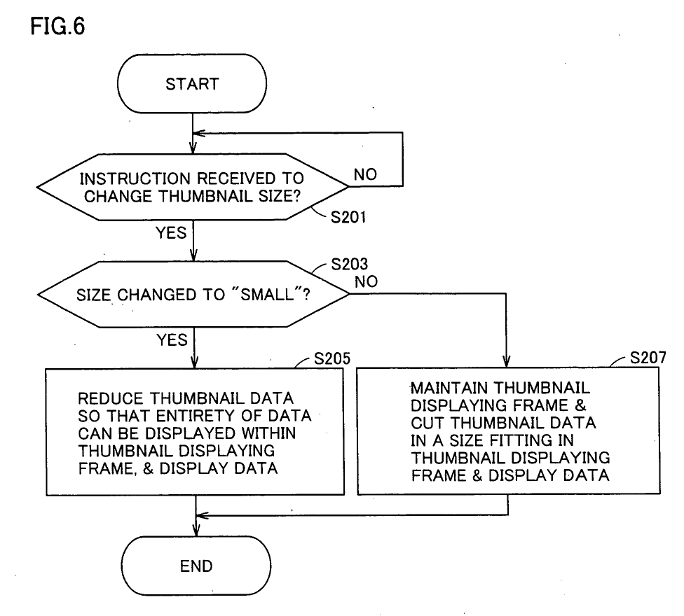

FIG. 6 is a flow chart of a process performed in the present embodiment's document management apparatus 100 when an instruction is issued to change a size of a thumbnail. The FIG. 6 process is implemented as a document management program is executed by CPU 131 and mainly the FIG. 4 functions are controlled.

With reference to FIG. 6, operation processor 103 receives instruction from a user operating mouse 137, keyboard 138 and/or the like to change a thumbnail size (YES at step S201), thumbnail range determiner 102 specifically analyzes the user's operation.

If the user's operation indicates that the thumbnail size should be changed to a minimum size (in the FIG. 13 specific example, “small”) (YES at step S203), thumbnail range determiner 1012 determines that the entirety of thumbnail data of document file to be thumbnailed and thus displayed is a range to be thumbnailed. Then cutter 1014 provides reduction to allow the entirety to be displayed within a thumbnail displaying frame of a predetermined size and develops the data in VRAM 136 as data to be displayed, and the data is thus displayed in a thumbnail (step S205).

If the user's operation indicates otherwise (in the FIG. 13 specific example, a “medium” or “large”) (NO at step S203) then thumbnail range determiner 1012 determines in accordance with the designated size (“medium” or “large”) a range to be thumbnailed of thumbnail data stored in thumbnail data storage 1072 and corresponding to document file to be thumbnailed and thus displayed. More specifically, thumbnail ranges corresponding to sizes are previously stored for example in memory 107 and a thumbnail range corresponding to a designated size (“in this example, “medium” or “large”) is read from memory 107.

Cutter 1014 cuts the determined range to be thumbnailed from thumbnail data and reduces or enlarges it and develops it in VRAM 136 as data to be displayed so that without a thumbnail displaying frame changed in size it is displayed in a predetermined size within the thumbnail displaying frame, and it is thus displayed in thumbnail (step S207).

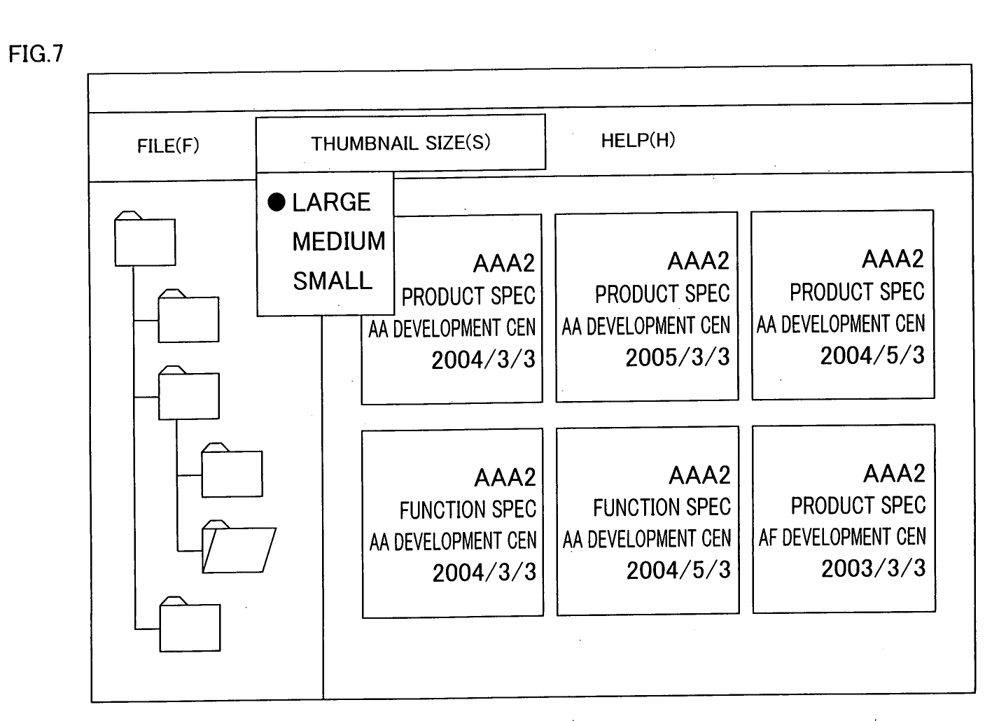

In the present embodiment document management apparatus 100 executing the thumbnail size modification process as described above can achieve displaying in a thumbnail as will be described specifically hereinafter. More specifically, if by way of example display 139 provides displaying in a thumbnail, as shown in FIG. 13, and a user performs an operation to change the thumbnail in size to “large” (NO at step S203), then, of thumbnail data, a thumbnail range smaller than the current thumbnailed range that corresponds to the thumbnail size “large” is determined as a range to be thumbnailed to be applied after the current thumbnails size is changed, and as shown in FIG. 7, data are displayed within the same thumbnail displaying frame as the FIG. 13 frame under large magnification.

Thus when the FIG. 13 thumbnail indication is changed in thumbnail size to “large”, the same number of thumbnails as before the previous thumbnail size is changed is still displayed, with each thumbnail displaying specific content (or document file) enlarged to help the user to find a desired document file, as shown in FIG. 7.

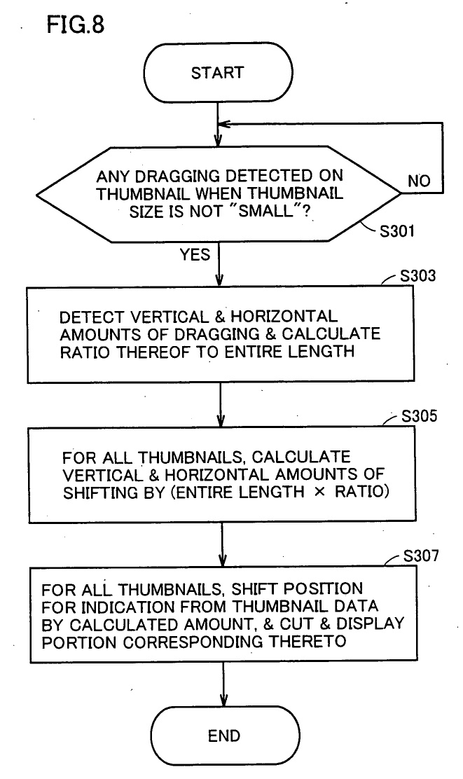

FIG. 8 is a flow chart of a process performed in the present embodiment by document management apparatus 100 when an instruction is received as a displayed thumbnail is for example dragged to change a position to be displayed. The FIG. 8 process is implemented as the document management program is executed by CPU 131 and mainly the FIG. 4 functions are controlled.

With reference to FIG. 8, if a thumbnail having a thumbnail size other than “small” is displayed and operation processor 103 receives an operation signal (for example of dragging) for example via mouse 137 dragged and/or keyboard 138 having a direction key pressed to indicate a positional change (YES at step S301), shift calculator 1013 detects an amount of shifting in vertical and horizontal directions and calculates a ratio thereof to the thumbnail's vertical and horizontal dimensions (step S303).

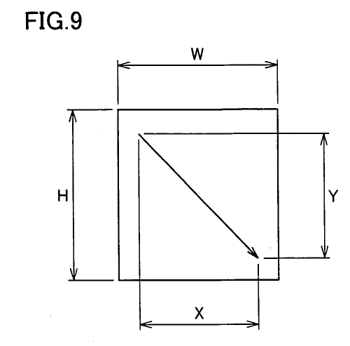

More specifically, with reference to FIG. 9, if for a thumbnail having a vertical dimension H and a horizontal dimension W an amount of shifting by a vertical length Y and a horizontal length X is designated, (or dragged), then at step S303 a ratio of an amount of shifting in the vertical direction (i.e., a length dragged in the vertical direction) Y to the thumbnail's vertical dimension H and a ratio of an amount of shifting in the horizontal direction (i.e., a length dragged in the horizontal direction) X to the thumbnail's horizontal dimension W are calculated.

Subsequently shift calculator 1013 uses the ratios calculated at step S303 and the vertical and horizontal dimensions of a document file (or a range thereof for which thumbnail data is generated) of each of all displayed thumbnails to convert a detected amount of shifting to that of shifting for each displayed thumbnail (step S305).

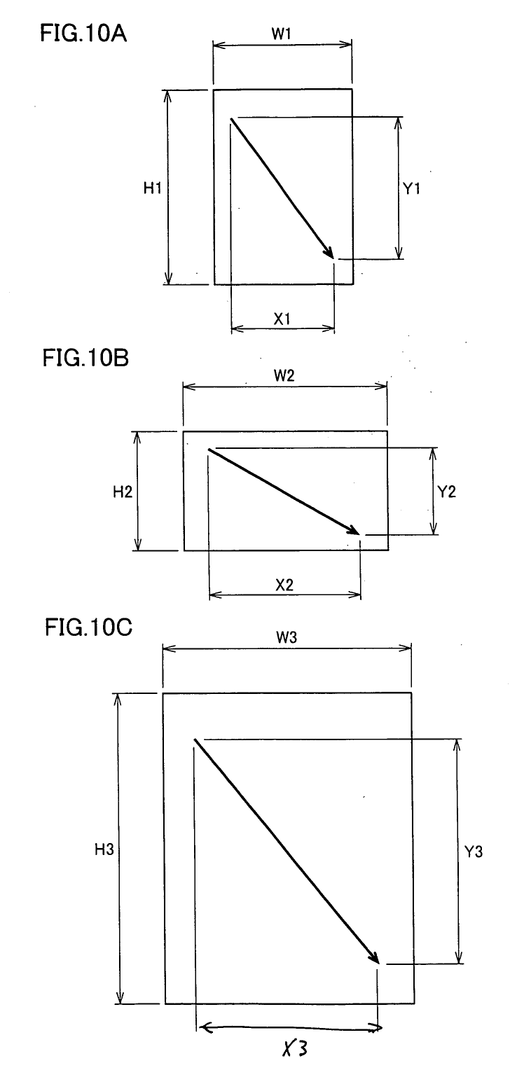

More specifically, at step S305, as shown in FIGS. 10A-10C, when thumbnails indicating a document file of the A4 size arranged vertically, a document file of the A4 size arranged horizontally and a document file of the A3 size arranged vertically are displayed, each document file's vertical length (H1, H2, H3) and horizontal length (W1, W2, W3) is multiplied by the aforementioned vertical ratio Y/H and horizontal ratio X/W so that an amount of shifting detected (X, Y) is converted to an amount of shifting in the vertical direction (Y1, Y2, Y3) and that of shifting in the horizontal direction (X1, X2, X3) for each document file's size.

Thumbnail range determiner 1012 uses an amount of shifting converted-for each document file obtained at step S305, the current thumbnail size (i.e., the current magnification of specific content of the thumbnail), and the current position in thumbnail to determine shifted thumbnail range for all of displayed thumbnails. Then cutter 1014 effects reduction or enlargement to allow the determined thumbnail range to be displayed within a thumbnail displaying frame of a predetermined size and developed in VRAM 136 as data to be displayed, and thus displayed in thumbnail (step S307).

When the present embodiment's document management apparatus 100 effects the above described process to change a thumbnail size which is not “small”, then, as described above, after the thumbnail size has been changed the same number of thumbnails as before the thumbnail size is changed is still displayed, with each thumbnail displaying enlarged content. As such, of thumbnail data, there will exist for each file an area which is not displayed in the thumbnail.

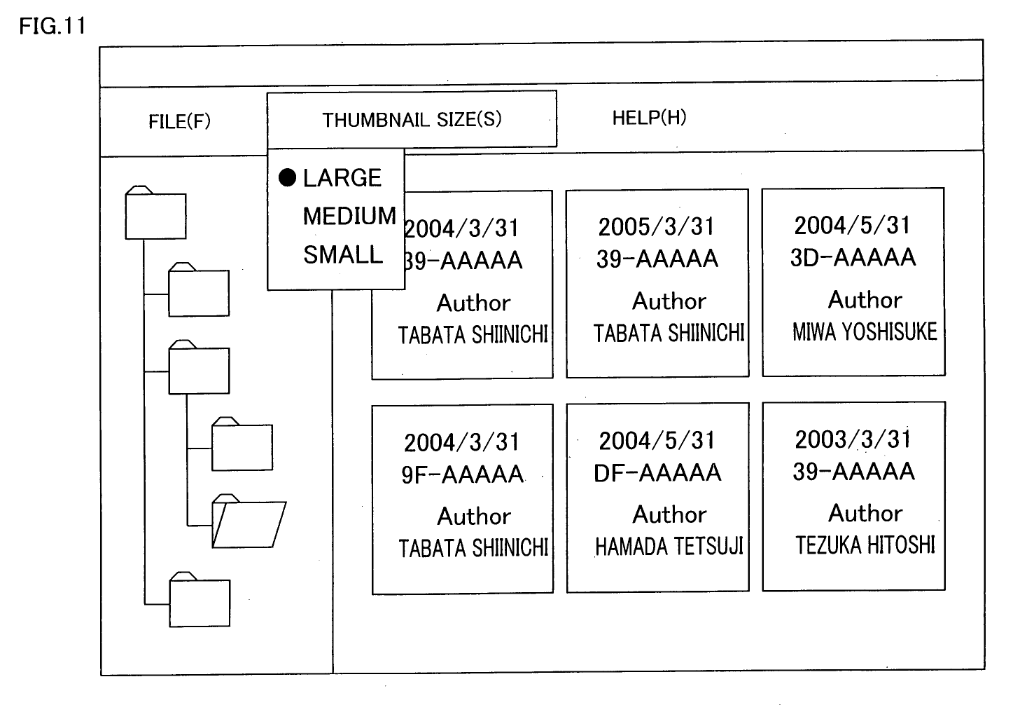

Accordingly in the present embodiment document management apparatus 100 executes process to change a position in a thumbnail for indication, as described above, as a dragging is made on the thumbnail to allow an undisplayed area to be displayed. Furthermore, this operation is intuitively, readily understood as dragging a mouse upwards as if to a drag a sheet thereby allows an image to have a lower portion displayed in a thumbnail. Furthermore, when thumbnails are displayed as shown in FIG. 7 and one of them is dragged, then as shown in FIG. 11, not only the dragged thumbnail but also all the other displayed thumbnails have their respective indications similarly moved and thus displayed so that all the thumbnails displays images at identical portions.

As such, if the thumbnail size “small” is adopted and with a currently displayed thumbnail the user cannot distinguish each file's content, the thumbnail size can be changed to “large” such that while the number of files displayed in thumbnail is unchanged, the user can perform an intuitive operation to compare a difference between the files in thumbnails and thus confirm the difference to distinguish the files and thus readily retrieve a desired file.

For example in the FIG. 11 example each file has a lower right portion indicating “Author” displayed in all thumbnails to help the user to find a file of a desired Author.

Furthermore the process that changes a position in a thumbnail for indication allows document files that thumbnails indicate (or those ranges of the document files for which thumbnail data is generated) to have their positionally identical portions displayed regardless of the document files' (or the ranges') sizes. For example, thumbnails indicating a document file of the A4 size arranged vertically (FIG. 10A), a document file of the A4 size arranged horizontally (FIG. 10B) and a document file of the A3 size arranged vertically (FIG. 10C), as shown in FIG. 10, are displayed in a single window, for the sake of illustration. If the thumbnail of the vertically arranged A4 document file displays an upper left portion the other thumbnails also displays their respective upper left portions. If a mouse or the like is dragged so that the thumbnail indicating the vertically arranged A4 document file has a position therein for indication moved in a rightward and downward direction to display a center of an image, the other thumbnails also display their respective images at the center, and when the thumbnail has a position therein for indication having arrived at a lower right corner, the other thumbnails simultaneously display their respective lower right corners, so that if the user can previously estimate where in a document file a particular area that the user is looking for exists, the user can simply drag any thumbnail to that particular area without considering document files' respective sheet sizes. All thumbnails can display their respective document files at uniform positions, respectively, so as to help the user to compare and distinguish the document files.

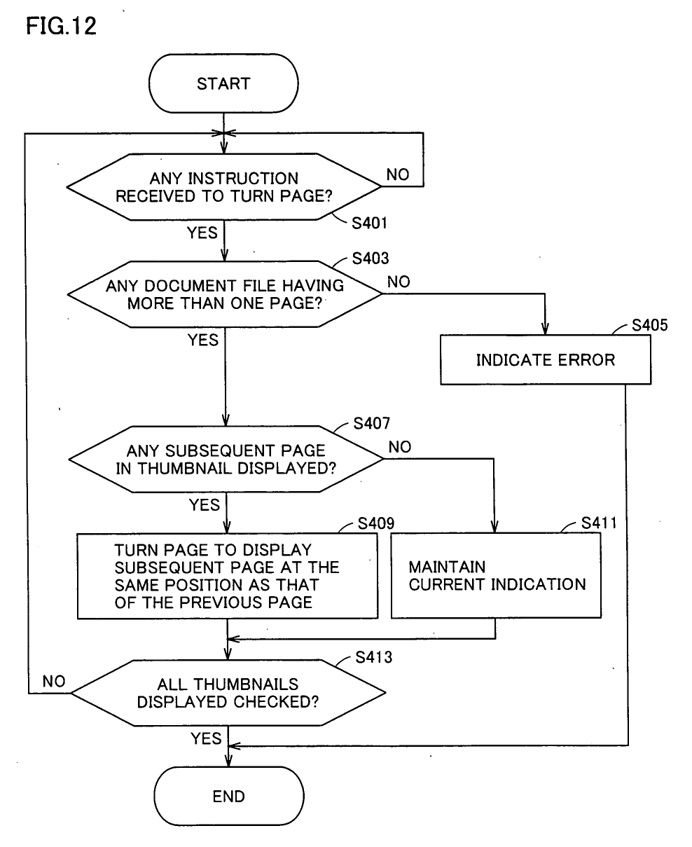

FIG. 12 is a flow chart of a process performed in the present embodiment by document management apparatus 100 to turn a page in displaying in thumbnails a group of document files including a document file having a plurality of pages. The FIG. 12 process is implemented as the document management program is executed by CPU 131 and mainly the FIG. 4 functions are controlled.

With reference to FIG. 12, when a thumbnail is displayed and operation processor 103 also receives an input of an operation from a user via mouse 137, keyboard 138 and/or the like to turn a page (YES at step S401), document manager 101 determines whether there exists any thumbnail indicating a document file having more than one page (step S403).

If not (NO at step S403) then there does not exist a thumbnail to be processed to turn a page, and display processor 105 effects a process to indicate error (step S405).

If there exists a thumbnail displayed indicating a document file having more than one page (YES at step S403), then thumbnail range determiner 1012 determines whether the page of the document file indicated in the thumbnail that is currently displayed is followed by a subsequent page (step S407).

If so, (YES at step 407), then thumbnail range determiner 1012 determines the subsequent page as a thumbnail range, and cutter 1014 cuts the determined thumbnail range out of thumbnail data and reduces or enlarges and develops it in VRAM 136 as data to be displayed so that without a thumbnail displaying frame changed in size it is displayed in a predetermined size within the thumbnail displaying frame, and it is thus displayed in the thumbnail (step S409).

If a thumbnail currently displays a document file at a portion corresponding to the document file's last page (NO at step S407) the thumbnail's indication is not changed (step S411).

If a user seeing a result displayed in a thumbnail at step S409 or S411 closes a file or for example double-clicks a particular thumbnail to select and display the thumbnail, and such user's operation is detected, a decision is made that the displayed thumbnail has been checked (YES at step S413) and a series of steps of the page turning process ends. If such operation as described above is not detected, a decision is made that the displayed thumbnail is unchecked (NO at step S413) and the control awaits the user's operation and when the user's operation indicating that a page should be turned is detected (YES at step S401), the above described process is repeated.

In the present embodiment document management apparatus 100 can execute a process to turn a page of a thumbnail, as described above, advantageously in that if displayed thumbnails include thumbnails indicating document files each having more than one page then the latter thumbnails can display the document files with their respective pages turned together.

As such, if thumbnailed contents of top pages of a plurality of document files, respectively, alone are insufficient for a user to distinguish the document files' contents, the user can similarly compare subsequent pages and thus compare the document files in further detail. For example, with reference to FIG. 11, if each thumbnail displays content of a document file on page 1 at a lower right portion and the above described thumbnail page turning process is effected then any thumbnails each indicating a document file having more than one page all display the document files' respective second pages at their respective lower right portions under the same magnification. As such, by combining a page turning operation and a dragging operation together, the above described thumbnail page turning process and the above described thumbnail size changing process can be combined together to allow any page to have any area thumbnailed and thus displayed to help a user to compare contents of documents in thumbnails.

Note that while in the above described thumbnail page turning process any thumbnails each indicating a document file having more than one page all display the document files with their respective pages turned together, only a selected thumbnail indicating a document file having more than one page can also be subjected to the above described thumbnail page turning process.

More specifically, at step S401 before an instruction is issued to turn a page the Ctrl key is pressed while a thumbnail is selected so that that a thumbnail to be paged (or not to be paged) has been selected is accepted and at step S407 and subsequent steps the selected thumbnail is set as a subject so that the selected thumbnail alone can be subject to the above described thumbnail page turning process.

Furthermore, in the above described process to change a thumbnail size and the above described process to change a position in a thumbnail for indication as well, at steps S201 and S301 before an instruction is issued (or a dragging is made) to change a size and a position the Ctrl key is pressed while a thumbnail is selected so that that a thumbnail to be thus changed (or not to be thus changed) has been selected is accepted and at steps S203 and S303 and subsequent steps the selected thumbnail is set as a subject so that the selected thumbnail alone can be subject to the above described processes to change a thumbnail size and a position in a thumbnail for indication.

There is a high possibility that a window displays a thumbnail indicating a document file that a user can previously determine is not a document file that the user wishes to find. In such a case, the user can press the Ctrl key while selecting a thumbnail to be a subject to thus select a plurality of thumbnails which can in turn be subjected to the above described processes to change a thumbnail size, a position in a thumbnail for indication, and/or turn a page of a thumbnail. Note that if these processes are selectively performed, preferably an unselected thumbnail is displayed in an order at a lower place and a window shows thumbnails selected to be processed arranged to precede and thus preferentially displayed. This can be achieved by rearranging thumbnails in display processor 105 when the user's selection is accepted at steps S203, S303, S403.

Furthermore, preferably, when a selected thumbnail is processed as described above, the Ctrl key is again pressed to select the thumbnail and such selection is accepted to clear the thumbnail's selected state indicating that the thumbnail is selected to be processed. Furthermore, in doing so, preferably the thumbnail having its selected state cleared is displayed in an order at a lower place. The thumbnail having its selected cleared may be excluded from a subsequent process or may undergo a process and as a result be displayed in a light color or the like indicating that the thumbnail now has its selected state cleared. Thus thumbnails selected to be processed can be narrowed down to a subject(s) to further, continuously be processed, and thus displayed.

Furthermore, the document management method performed by document management apparatus 100 as described above can be provided in the form of a program. Such program can be stored in a computer readable storage medium such as a flexible disk, a CD-ROM, a ROM, a RAM, a memory card or the like included in a computer, and provided as a program product. Alternatively, the program may be provided in a storage medium such as a hard disk incorporated in a computer. Alternatively, it may be downloaded through a network and thus provided.

Note that while in the present embodiment a computer is exemplified as the present document management apparatus, the present document management apparatus is also applicable to an image processing apparatus such as multifunction peripherals (MFP).

More specifically, the present document management apparatus is suitably used when an image, a document or the like stored in each box provided in a hard disk of the MFP is displayed in a thumbnail on a liquid crystal single-touch display unit of a console panel of the MFP. Size-switching and page-turning are settable by introducing a key therefor on the liquid crystal single-touch display unit and a position for indication can be shifted by selecting any thumbnail with a single touch and using numeral keys to input an amount of shifting.

The provided program product is installed in a hard disk or similar program storage and executed. Note that the program product includes the program itself and a storage medium having the program stored therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information management program product causing a computer to execute an information management process comprising the steps of:
generating thumbnail data based on a data file and employed to display a thumbnail indicating said data file;
designating a size of said thumbnail; and
determining a thumbnail range serving as a range of said thumbnail data that is displayed as said thumbnail, said thumbnail range being determined as based on a predetermined size of an area displaying a single thumbnail, and a magnification of content displayed as said thumbnail that corresponds to said size of said thumbnail designated in the step of designating.

2. The program product according to claim 1, wherein in the step of determining, said thumbnail range is determined for a displayed thumbnail designated.

3. A program product causing a computer to execute an information management process comprising the steps of:
generating first thumbnail data based on a first data file and employed to display a first thumbnail indicating said first data file, and second thumbnail data based on a second data file and employed to display a second thumbnail indicating said second data file;
determining a first thumbnail range serving as a range of said first thumbnail data that is displayed as said first thumbnail, and a second thumbnail range serving as a range of said second thumbnail data that is displayed as said second thumbnail;
detecting for said first thumbnail displayed an instruction indicating that said first thumbnail range should be shifted; and
shifting said first thumbnail range and said second thumbnail range in response to said instruction detected in the step of detecting.

4. The program product according to claim 3, wherein:
the step of detecting detects a first amount of shifting indicated for said first thumbnail displayed; and
the step of shifting further includes the steps of
converting said first amount of shifting detected at the step of detecting to a second amount of shifting for said second thumbnail displayed, and
calculating, from said first and second amounts, first and second amounts of shifting said first and second thumbnail ranges on said first and second thumbnail data, respectively.

5. The program product according to claim 4, wherein in the step of calculating, a third amount of shifting is calculated for a displayed thumbnail designated.

6. A program product causing a computer to execute an information management process comprising the steps of:
generating thumbnail data based on a data file and employed to display a thumbnail indicating said data file;
determining a thumbnail range serving as a range of said thumbnail data that is displayed as said thumbnail; and
entering an instruction to turn to a subsequent page a thumbnail range of said thumbnail displayed, wherein if in the step of determining, a displayed thumbnail indicating a data file having more than one page currently displays a page of said data file followed by any subsequent page of said thumbnail range, then in response to said instruction the subsequent page is determined as said thumbnail range.

7. The program product according to claim 6, wherein if in the step of determining, a displayed thumbnail that indicates a data file having more than one page and is designated currently displays a page of said data file followed by any subsequent page of said thumbnail range, then in response to said instruction the subsequent page is determined as said thumbnail range.

8. A program product causing a computer to execute an information management process comprising the steps of:
displaying in a thumbnail at least one data file having more than one page by using said page;
receiving an instruction indicating that for said thumbnail displayed, a page should be turned; and
changing said data file's thumbnailed and displayed portion in response to said instruction from a currently displayed page to a subsequent page.

9. The program product according to claim 8, wherein:
the step of displaying includes the step of thumbnailing and displaying a page of each of more than one said data file; and
the step of changing includes the step of changing a thumbnailed and displayed portion of said data file of each of displayed, more than one said thumbnail from a currently displayed page to a subsequent page.

10. The program product according to claim 8, wherein in the step of changing, a decision is made as to whether said thumbnail displayed is a thumbnail indicating a data file having more than one page and if so said thumbnail has a thumbnailed and displayed portion of said data file turned from a currently displayed page to a subsequent page.

11. A program product causing a computer to execute an information management process comprising the steps of
displaying a first thumbnail based on a first data file and indicating said first data file;
displaying a second data file based on a second data file and indicating said second data file;
detecting for said first thumbnail displayed an instruction indicating that a range to be displayed should be shifted; and
shifting a range of said second thumbnail to be displayed as based on said instruction detected in the step of detecting.

12. An information management apparatus comprising:
a thumbnail generator generating thumbnail data from a data file for displaying a thumbnail indicating said data file;
a designator designating a size of said thumbnail; and
a thumbnail range determiner determining a thumbnail range serving as a range of said thumbnail data that is displayed as said thumbnail, said thumbnail range being determined as based on a predetermined size of an area displaying a single thumbnail, and a magnification of content displayed as said thumbnail that corresponds to said size of said thumbnail designated by said designator.

13. The information management apparatus according to claim 12, wherein said thumbnail range determiner determines said thumbnail range for a displayed thumbnail designated.

14. An information management apparatus comprising:
a thumbnail generator generating first thumbnail data based on a first data file and employed to display a first thumbnail indicating said first data file, and second thumbnail data based on a second data file and employed to display a second thumbnail indicating said second data file;
a thumbnail range determiner determining a first thumbnail range serving as a range of said first thumbnail data that is displayed as said first thumbnail, and a second thumbnail range serving as a range of said second thumbnail data that is displayed as said second thumbnail;
a detector detecting for said first thumbnail displayed an instruction indicating that said first thumbnail range should be shifted; and
a shifter shifting said first thumbnail range and said second thumbnail range in response to said instruction detected by said detector.

15. The information management apparatus according to claim 14, wherein:
said detector detects a first amount of shifting indicated for said first thumbnail displayed; and
said shifter includes
a converter converting said first amount of shifting detected by said detector to a second amount of shifting for said second thumbnail displayed, and
a shift calculator calculating, from said first and second amounts, first and second amounts of shifting said first and second thumbnail ranges on said first and second thumbnail data, respectively.

16. The information management apparatus according to claim 15, wherein said shift calculator calculates a third amount of shifting for a displayed thumbnail designated.

17. An information management apparatus comprising:
a thumbnail generator generating thumbnail data based on a data file and employed to display a thumbnail indicating said data file;
a thumbnail range determiner determining a thumbnail range serving as a range of said thumbnail data that is displayed as said thumbnail; and
an indicator entering an instruction indicating that said thumbnail's displayed thumbnail range should be turned to a subsequent page, wherein if a displayed thumbnail indicating a data file having more than one page currently displays a page of said data file followed by any subsequent page of said thumbnail range, then in response to said instruction said thumbnail range determiner determines the subsequent page as said thumbnail range.

18. The information management apparatus according to claim 17, wherein if a displayed thumbnail that indicates a data file having more than one page and is designated currently displays a page of said data file followed by any subsequent page of said thumbnail range, then in response to said instruction said thumbnail range determiner determines the subsequent page as said thumbnail range.

19. An information management apparatus comprising:
a display displaying in a thumbnail at least one data file having more than one page by using said page;
an indicator receiving an instruction indicating that for said thumbnail displayed, a page should be turned; and
a changer operative in response to said instruction to change said data file's thumbnailed and displayed portion from a currently displayed page to a subsequent page.

20. The information management apparatus according to claim 19, wherein:
said display displays a page of each of more than one said data file; and
said changer changes a thumbnailed and displayed portion of said data file of displayed, more than one said thumbnail from a currently displayed page to a subsequent page.

21. The information management apparatus according to claim 19, wherein said changer determines whether said thumbnail displayed is a thumbnail indicating a data file having more than one page and if so changes a thumbnailed and displayed portion of said data file of said thumbnail from a currently displayed page to a subsequent page.

22. An information management apparatus comprising:
a first display displaying a first thumbnail based on a first data file and indicating said first data file;
a second display displaying a second data file based on a second data file and indicating said second data file;
a detector detecting for said first thumbnail displayed an instruction indicating that a range to be displayed should be shifted; and
a shifter shifting a range of said second thumbnail to be displayed as based on said instruction detected in the step of detecting.
